(19) United States
(12) Patent Application Publication
(10) Pub. No.: US 2009/0234992 A1
(43) Pub. Date: Sep. 17, 2009

(54) Geiser Device- A no hassle link

(76) Inventor: SHEHU BANKOLE-HAMEED, (US)

Correspondence Address: Shehu Bamkole-Hameed, Ste. 705-110, 1163 E. Ogden Avenue, Naperville, IL, 60563, US

(21) Appl. No.: 12/049,897

(22) Filed: Mar. 17, 2008

(51) Int. Cl. G06F 13/12

(52) U.S. Cl. 710/72

(57) ABSTRACT

Many peripherals communicate with computers through Universal Serial Bus, which is the natural candidate for mobile point-to-point connectivity. The major issue associated with this connectivity is that USB employs a master-slave protocol, which relies on the intelligence of the host. Since all USB logical devices presents the same basic interface to the host. This allows the host to manage the relevant aspects of different the device in the same manner. The management assists the host in identifying and configuring the USB device interface while it carries and reports configuration related information. Some information reported is common among all logical devices. Other information is specific to the functionality provided by the device.

Geiser Device is a universal device that allows for all document format data recognition as presently obtained in all cases of computer with USB adaptors. This technology communicates directly with its embedded descriptor system and a recognizing program document in the reproduction devices (printers and photocopiers) without having to connect any additional device, or use a single USB cable or personal computer as a host.

It enables these document reproduction devices (printers and photocopiers) to achieve all that is being presently available in computers, for document reproduction in photocopiers and printers, storage and transfer of data and images as in cameras and phones.

### BACKGROUND OF THE INVENTION

Computers are obviously becoming an integral part of our life. Virtually nothing is engineered and manufactured today without computers affecting the design, manufacturing and its operation. Therefore, the current uses of electronic devices with embedded descriptor systems are now part of our daily lifestyle. Examples of such devices include printers, photocopiers, handheld calculators, mobile telephones, DVD players etc. In broad definition, embedded computer systems are characterized by providing a function (or functions) that is not itself a computer. Generally, an embedded computer system contains special-purpose hardware and a processor (CPU) supporting a Real-Time Operating System (RTOS). The system is programmed with special-purpose software tailored to meet the requirements for that particular system.

Electronic devices are defined as instruments that accomplish their purpose electronically which includes printers, photocopiers, cameras, scanners, televisions, computers, VCRs, cell phones, telephones, and radios and so on.

The major problem with today's electronic devices such as photocopiers, printers, cameras and mobile phones with embedded descriptor system is that their limited function depends solely with their connection to a computer for their operation related to softcopy and hardcopy document/data retrieval. Specifically the operation of mobile phone related to hardcopy document/data retrieval does not exist. In the case of cameras, softcopy and hardcopy document/data retrieval does not exist only pictorial images are possible. In case of photocopiers and printers hardcopy document/data is possible only through added Universal Serial Bus (USB) cable or wired/wireless connections to a computer. The entire prior art cannot operate and function by itself without the connection to a cable and/or a host computer and even cameras in the case of photo printers. The issues and limitations of such embedded computer system is the focus of this invention and the proposed solutions are provided in this embodiment.

The field of this invention relates to a universal serial bus (USB) device, and more particularly, a USB device that self initializes with a real descriptor embedded in a USB host within its interface and it's method of initialization.

This invention relates to an embedded descriptor system for document reproduction including any devices that can accept data form for either physical reproduction/storage or as in the case of cell phones for visual purpose. Geiser Device is a universal device that allows for all document format data recognition as presently obtained in all cases of computer with USB adaptors. Geiser Device is an improvement on the existing products because it communicates directly with document reproduction devices without having to connect any additional devices or use a single USB cable or to download any data for reproduction purposes. Geiser Device serves as an interface for uploading information unto devices such as photocopiers, printers, cameras and mobile phones. It allows for download of stored data in external storage devices from sources aforementioned.

Geiser Device is an improvement on all previously mentioned devices with capability to store data for the purpose of retrieval or re-use. Geiser Device enables these peripheral devices or document reproduction devices, for example, printers and photocopiers to achieve all that is being presently achievable in the case of computers.

This invention eliminates both the processes and uses of additional devices (i.e. an external camera, its USB cable connection and computer) and connections with the reproduction machines.

This invention, Geiser Device when compared with existing products would therefore be desirable as a replacement to provide data format document reproduction, having an embedded computer system, with improved functionality and flexibility.

The limited functionality in mobile phones uses cable connection with portable device adaptor and computer for document reproduction. Similarly, cable connection with computer is used in case of the cameras. This limitation allows pictorial images to be printed from digital cameras. This is accomplished with the use of a single USB cable to a printer. This limitation is the solution proposed in this disclosure embodiment. A major advantage of Geiser Device is its simplicity for the user, and especially for document reproduction without the use of a single USB cable or a computer.

For example: Geiser device is used to read data format directly from existing External Storage Drive (ESD) and which may then be directly printed, copied or faxed document as desired by the user selection.

For example: When an external storage device e.g. Flash Drive is inserted into a computer, there is a driver option within the personal computer to directly recognizes the inserted device and its contents. Furthermore, to explore the external storage device's content after which, to make selection from these stored content for any action that is permissible within the application system.

This whole process, operation and execution as described above are not presently obtained or possible within all documentation reproduction devices like Printers or Photocopiers. Geiser Device technology makes it possible.

This new technological invention described in this embodiment is applicable to both pictorial images and data document recognition with software recognition interface that is capable of recognizing document format, reading document format and allowing the information data to be printed, copied or faxed directly from the Geiser Device interface for Document Reproduction Machine—Printer/Copier/Fax Machine.

Essentially Geiser Device is being disclosed to allow interface and software recognition in pictorial images and or data document format. The existing software technology for document recognition that is already in use in today's computers will be employed and modified for adaption and to be used in Geiser Device, for storage and transfer—re-use in electronic devices.

The field of this invention relates to a universal serial bus (USB) device, and more particularly, a USB device that self initializes with a real descriptor embedded in a USB host within and it's method of initialization.

### DESCRIPTION OF THE RELATED ART

In general, a USB device is an interfacing device for connecting peripheral equipments such as photocopiers, printers, cameras and mobile phones, etc., to a USB host. The USB device is first initialized to allow the peripheral equipments to communicate with the USB host. Meanwhile, the USB host stores a real descriptor and a descriptor recognizing program to initialize the USB device.

FIG. 1 is a block diagram of a conventional USB device. In the conventional USB device shown in FIG. 1, a descriptor reads/write portion 12 of a USB interface 10 reads a descriptor stored in an additional memory 20 and then, transfers the descriptor to a register 14 and stored in the register. The reads descriptor includes the information (Operating System and Driver) of a vendor I.D. and a product I.D. for a host 1.

An initialization signal generator 18 in the USB interface 10 activates an initialization signal and a voltage regulator 30 pulls up a signal line 40 in response to the initialization signal. That is, a transistor 32 in the voltage regulator 30 is turned ON, and then a terminal voltage V_{DD} is transferred to the signal line 40 through a resistor 34.

The descriptor read/write portion 12 reads the stored descriptor in the register 14, and provides the descriptor to the USB host 1 through a USB core 16 and the signal line 40. When a descriptor recognizing program 1a of the USB host 1 recognizes the descriptor provided from the USB interface 10, the initialization of the conventional USB device is completed. Generally, the additional Read Only Memory 20 is a ROM that is positioned at outside of the USB interface 10, so that the descriptor can be queued. However, the conventional USB device has disadvantages in points of the chip size and the manufacturing cost due to the additional memory 20 positioned at the outside of the USB interface 10.

### SUMMARY OF THE INVENTION

Substantial amount of peripherals are communicating with computers through Universal Serial Bus, the natural candidate for mobile point-to-point connectivity. The major issue associated with this connectivity is that USB employs a master-slave protocol, which relies on the intelligence of the host. The host stores a real descriptor and a descriptor recognizing program. In a first aspect, there is provided a peripheral document reproducing device, named Geiser Device, comprising of an embedded descriptor system with a recognizing program, said Geiser Device comprising a processor supporting a real-time operating system (RTOS) that functions by itself without the connection to a USB cable or a personal computer.

The Geiser Device includes an interface, a signal line and a voltage regulator. The interface stores a basic descriptor, activates an initialization signal and transfers the basic descriptor to the embedded host in order to perform an initialization. The interface acknowledged the descriptor and down load command generated from the embedded host and then activates the initialization signal and transfer descriptor back to the host.

The signal line guides the basic descriptor, the real descriptor and the download command. The signal line guides the data and commands to the embedded host. The interface stores a basic descriptor. The interface activates an initialization signal and transfers the basic descriptor to the host in order to perform a primary initialization.

The voltage regulator pulls up the signal line while the initialization signal is activated. Method for initializing a USB device connected to a host which stores a real descriptor and a descriptor recognizing program. The initializing method comprises the steps of
a) Performing a primary initialization with a basic descriptor stored in a ROM type memory
b) Receiving the real descriptor and a download command generated from the host

Geiser Device, as used herein, as the term document reproducing device relates to an embedded descriptor system and recognizing program for document and pictorial imaging printing, copying, faxing or storage.

In the present invention, Geiser Device is considered a universal device that allows for all document format data recognition as presently obtained in all cases of personal computer with USB adaptors.

A major advantage of Geiser Device is an improvement on the existing products in the market because it communicates directly with document reproduction devices without having to connect any additional device, for example, without the use of a single USB cable or personal computer as a host.

The Geiser Device enables these document reproduction devices (printers and photocopiers) to achieve all options that are being presently achievable without the need for connection to computers as a host.

This present invention eliminates both the processes and uses of additional devices, for example, (an external camera, its USB cable connection and personal computer) and connections with the reproduction machines.

This present invention, the Geiser Device when used with the existing manufactured products like printer, the Geiser Device would therefore be desirable as a replacement to provide data format document reproduction, having an embedded descriptor system and descriptor recognizing program, with improved portability, functionality and flexibility.

This present invention, the Geiser Device when used with the existing manufactured products like cell phones with added capability to store directly and transfer data directly to external storage device, the Geiser Device would therefore be desirable as a replacement to provide data format document reproduction, having an embedded descriptor system and descriptor recognizing program, with improved portability, functionality and flexibility.

The solution proposed in this present invention allows data format document and pictorial images format to be printed directly without the use of digital cameras or use of a single USB cable to a printer, or having to connect to a personal computer. A major advantage of Geiser Device is its simplicity and portability for the user, and especially those users who desire to print data formatted document directly.

By connecting a Geiser Device-enabled printer device without using a single USB cable, users can easily control print settings using existing display and produce data document without using a computer.

### DESCRIPTION OF THE PREFERRED EMBODIMENTS

FIG. 2 is a block diagram of a Geiser Device according to one exemplary embodiment of the invention. Referring to FIG. 2, the Geiser Device includes an interface 100, a voltage regulator 200 and one signal (D+, D−) line 250. The interface 100 has a basic memory 110, a descriptor read/write portion 120, a register 130, a command analyzing portion 140, an initialization signal generator 160, and a USB core 170. The interface 100 manages communication on the basis of a USB protocol. The basic memory 110 stores a basic descriptor when a Read Only Memory is used as the basic memory. When an external power supply to the interface 100 is cut off, the basic memory 110 stores the basic descriptor. The basic descriptor includes a common vendor I.D. (Microsoft, Linux, etc. and a common product I.D. that is stored in the basic memory during manufacturing. Therefore, the information in the basic descriptor would be equivalent to the real information for an embedded host that resides insides the interface. The descriptor read/write portion 120 reads the basic descriptor stored in the memory 110, when the external power is supplied to the interface 100. The descriptor read/write portion 120 transfers the basic descriptor to the embedded host, when the signal line is 250 is pulled up through the USB core 170 and the signal line 250. The register 130 stores the real descriptor transferred from descriptor read/write portion 120. The command analyzing portion 140 receives the real descriptor and downloads command provided from the residing embedded host 1 and activates the download start signal. Then, the command analyzing portion 140 provides the download start signal and the real descriptor to the descriptor read/write portion 120.

An initialization signal is activated when the external power voltage is supplied to the Geiser Device. The initialization signal controls the voltage regulator 200. The activation of the initialization signal is terminated in response to the activation of the control signal. The USB core 170 is connected to the residing embedded host 1 inside the device via the signal line 250. The USB core 170 receives the download command and the real descriptor from the embedded host 1 and transfers them to the command analyzing portion 140. The USB core 170 receives the basic descriptor and real descriptor from the descriptor readtwrite portion 120 and transfers them to the embedded host 1 through the signal line 250. The voltage regulator 200 has a transistor 210 connected to a terminal voltage V_{DD} and a resistor 220. The resistor 220 is positioned between the transistor 210 and the signal line 250. The transistor 210 is turned ON while the initialization signal is in the state of activation. Then the voltage regulator 200 supplies the terminal voltage V_{DD} to the signal line 250 and the signal line 250 is pulled up. In this case, the Geiser Device can transfer/receive data, such as the real descriptor, the basic descriptor, etc., and the download command to/from the residing embedded host 1 through the signal line 250. The voltage regulator 200 is turned off when the initialization signal is terminated. In this case, the signal line is pulled down and the communication between the Geiser Device and the residing embedded host 1 is terminated.

FIG. 3 is a flowchart for explaining a method of initializing the Geiser Device illustrated in FIG. 2. In FIG. 3, an external power is supplied to the Geiser Device at step 305. Then, the initialization signal generator 160 activates the initialization signal at step 310. In this case, the transistor 210 of the voltage regulator 200 is turned ON and the terminal voltage V_{DD} is transferred to the signal line 250 at step 315 indicating that the signal line 250 is pulled up.

The descriptor read/write portion 120 reads the basic descriptor stored in the basic memory 110 and transfers the basic descriptor to the embedded host through the USB core 170 and the signal line 250 to perform the primary initialization at step 320. When the descriptor recognizing program 1 of the embedded host recognizes the basic descriptor, then the primary initialization of the Geiser Device is completed. In this state, the embedded host provides the real descriptor and the download command to the Geiser Device 100 through the signal line 250. The command analyzing portion 140 receives the real descriptor and download command through the USB core 170 at step 325. The command analyzing portion 140 generates the download start signal and provides the real descriptor to the descriptor read/write portion 120. Then the descriptor read/write portion 120 downloads the real descriptor from the command analyzing portion 140 in response to the download start signal at step 330 and transfers the real descriptor to the register 130 at step 335 and the descriptor read/write activates the download completion. The initialization signal 160 terminates the primary activation of the initialization signal in response to the primary activation of the control signal at step 340. The transistor 210 of the voltage regulator is turned OFF and the transferring of the terminal voltage V_{DD} to the signal line 250 is cut off at step 345. Therefore, the acknowledgement between the embedded host 1 and the Geiser Device is terminated.

FIG. 4a illustrates the application of a document/data reproducing device, a printer 405 having a slot with an embedded descriptor system and descriptor recognizing program, a Geiser Device 415 that allows an External Storage Device 410 direct connection 420 without a cable or computer for document/data reproduction.

FIG. 4b illustrates the application of a document/data reproducing device, a scanner 425 having a slot with an embedded descriptor system and descriptor recognizing program, a Geiser Device 435 that allows an External Storage Device 430 direct connection 440 without a cable or computer for document/data reproduction.

FIG. 4c illustrates the application of a document/data reproducing device, a cell phone 445 having a slot with an embedded descriptor system and descriptor recognizing program, a Geiser Device 455 that allows an External Storage Device 450 direct connection 460 without a cable or computer for document/data reproduction.

FIG. 4d illustrates the application of a document/data reproducing device, a hand held computer 465 having a slot with an embedded descriptor system and descriptor recognizing program, a Geiser Device 475 that allows an External Storage Device 470 direct connection 480 without a cable or computer for document/data reproduction.

Geiser Device is encoded and enhanced with an embedded descriptor system and descriptor recognizing program that provides the capability of operating without the physical connection with a personal computer or USB cable connection. Its operation allows direct interfacing with document reproduction devices or Human Interface Devices (HID) like Printers/Photocopiers, cell phones and provides options to the user to select choice of operation from either to print document, copy document or fax the document, storage and transfer. This disclosed embodiment would combine the present allowable format and process recognition, including transfer for reproduction purposes.

Geiser Device is encoded and enhanced with the capability of operating without the physical connection with a computer. Its processing steps and operation allows direct interfacing with document reproduction devices as shown in FIG. 2 like Printer/Photocopier and allows the user to select choice of operation from either to print, copy, or fax the document. The processing steps begin as follows:

Step 1: Insert an External Storage Device (ESD) device with pre-stored document format into Geiser Device slot.

Step2: Geiser Device descriptor initializes, recognizes, and reads, and then downloads and transfer information of document stored in the ESD by opening up all the stored data.

Step3: The entire document format is now displayed in the existing display unit in the Human Interface Devices as mentioned above.

Step4: Option for selection is now granted to the user. The option might include Print doc., Fax doc., Fax doc., or Print/Fax, etc.

Step 5: The user makes choice of function visible by display in a display screen and document function choice is executed on the Human Interface Devices.

Step 6: Present choices in display to Print, Copy, Fax for document placed directly either on the indicator glass or in the screen.

### BRIEF DESCRIPTION OF THE DRAWINGS

The foregoing and further features and advantages of the invention will become more apparent from the following description and the accompanying drawings, in which the same reference numerals indicated the same corresponding parts:

FIG. 1 is a block diagram of a conventional USB device.

FIG. 2 is a block diagram of a Geiser Device according to one exemplary embodiment of the invention.

FIG. 3 is a flowchart for explaining a method of initializing the Geiser Device illustrated in FIG. 2

FIG. 4a, 4b, 4c, 4d Geiser Device illustrating direct operation with Human Interface Devices (HID's) such as printers, scanners, cell phone and hand held computer for printing, for storage and transfer without cable or computer connection.

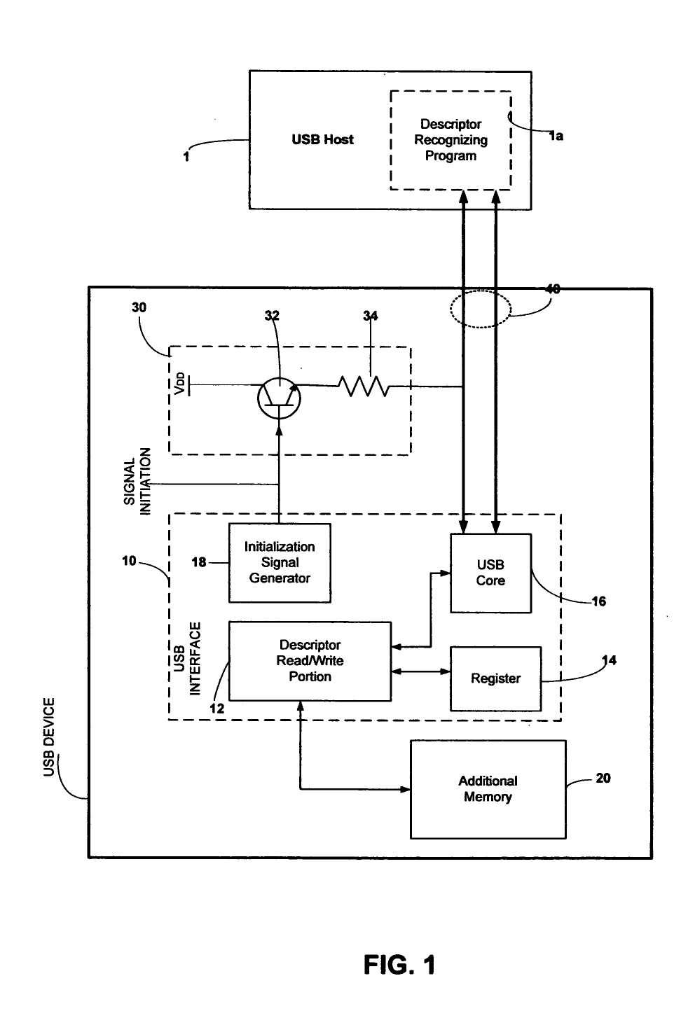

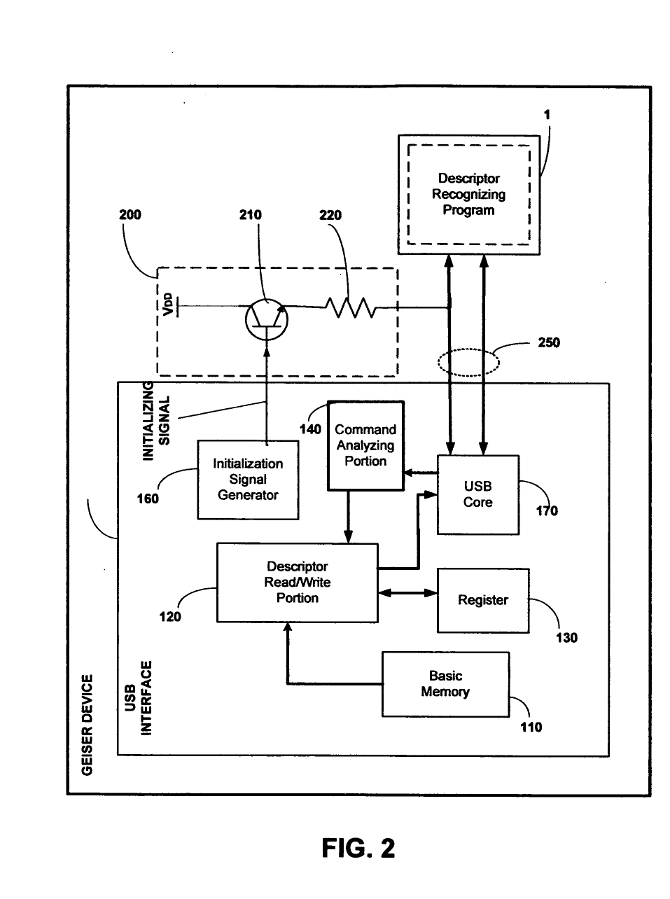

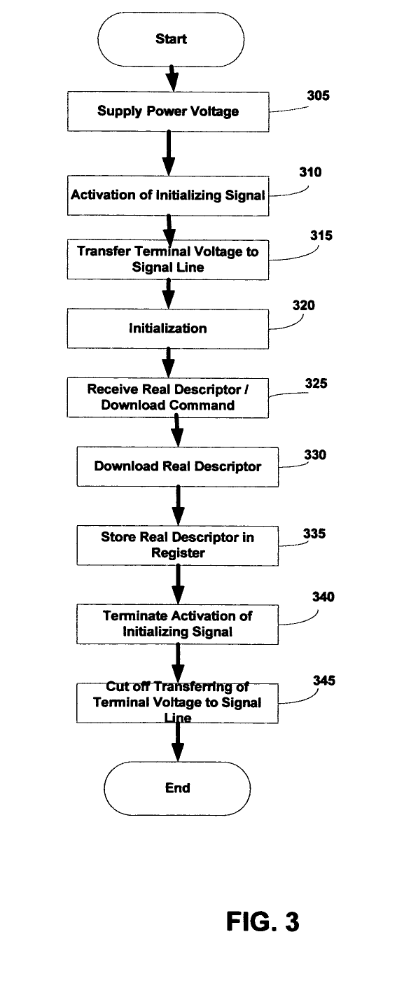

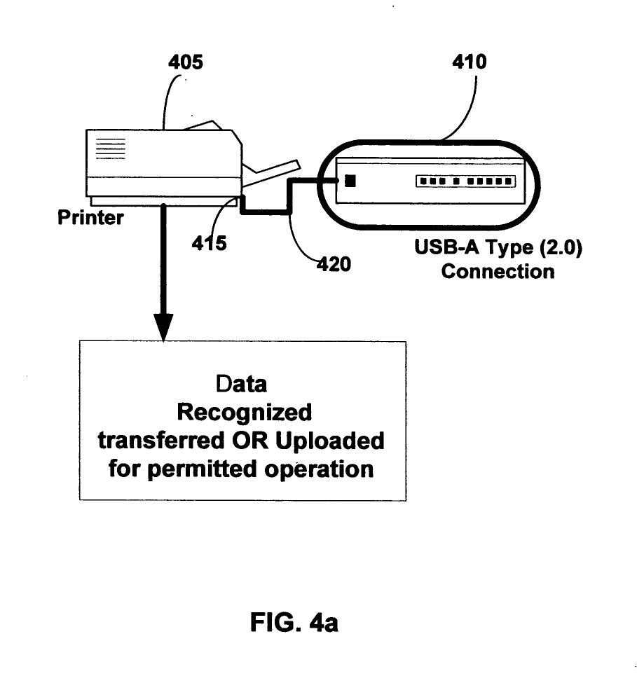

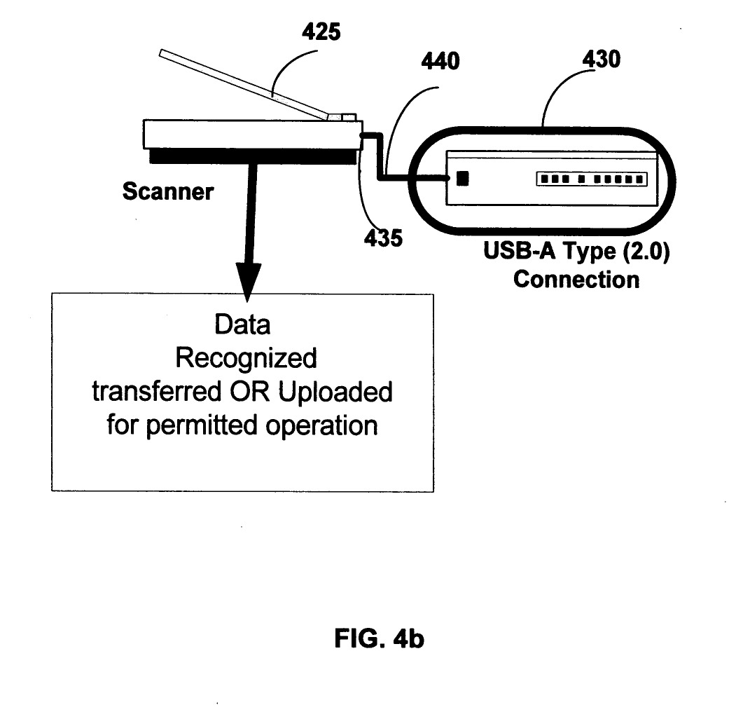

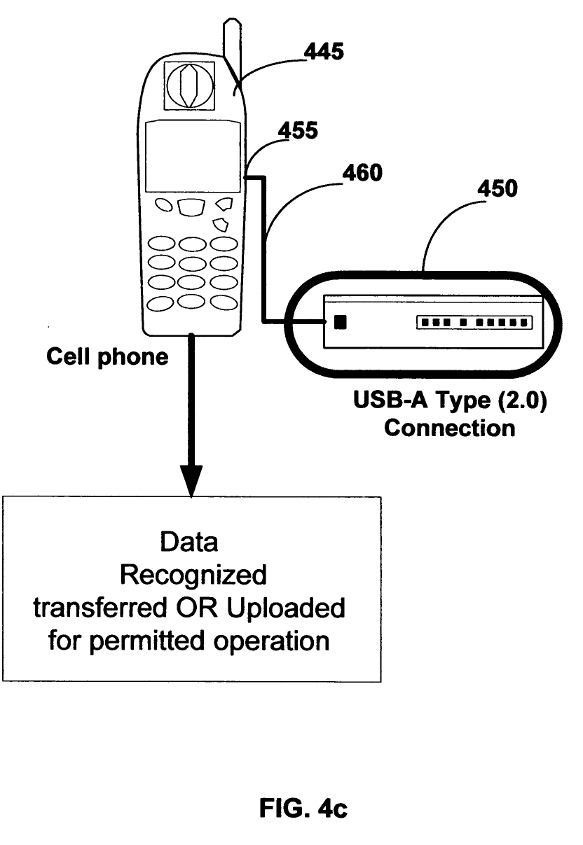

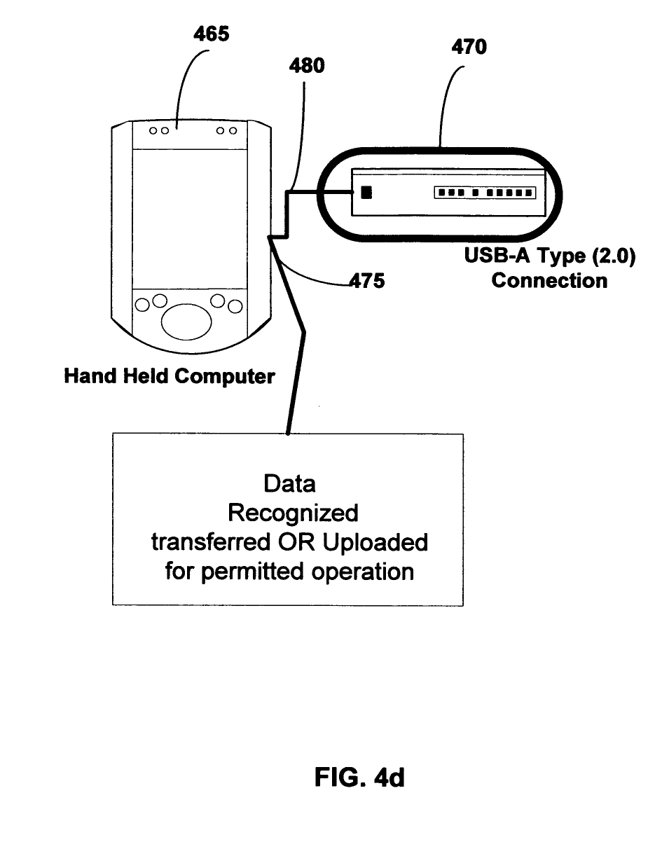

### REFERENCES CITED

1. U.S. Pat. No. 6,009,480, December 1999, Pleso, Mark, F
2. U.S. Pat. No. 6,088,785, July 2000, Hudson, Michael, Moore, Daniel L.
3. U.S. Pat. No. 6,490,637, December 2002, Shih, Liang-Kuang
4. U.S. Pat. No. 6,523,081, February 2003, Karlsson, Magnus G., Moody, Michael J., Christison, Gregory Lee
5. U.S. Pat. No. 6,868,456, March 2005, Kim, Do Hyung

1. Geiser Device is a system having an external slot with a host that resides inside the interface as a device that allows for embedded descriptor system and recognizing program comprising: an interface with embedding descriptor, the interface activates an initialization signal and transfers the basic descriptor to the residing host to perform an initialization, the interface downloading the real descriptor in response to a download command generated from the residing host, and a signal line for guiding the basic descriptor, the real descriptor and the download command, and the signal line is being enabled with a terminal voltage; a voltage regulator providing the terminal voltage to the signal line while the initialization signal is activated; a memory storing the basic descriptor; a register for storing the real descriptor generated from the residing host; a command analyzing portion receiving the real descriptor and the download command from the residing host and generating a download start signal; and a descriptor read/write portion transferring the basic descriptor stored in the memory to the residing host, the descriptor read/write portion transferring the output of the real descriptor from the command analyzing portion to the register in acknowledging a response to the download start signal and generating a download completion signal and providing the real descriptor stored in the register to the residing host.

2. The Geiser Device in accordance with claim 1, wherein the memory is a read only memory (ROM).

3. The Geiser Device in accordance with claim 1, wherein the voltage regulator comprises: a transistor connected to a predetermined terminal voltage; and a resistor being disposed between the transistor and the signal line.

4. Geiser Device aforementioned in claim 1 directly initializes and transfers all forms of document/data and images.

5. The said embedded descriptor system and descriptor recognizing program as in claim 1 provides the capability of operating without the physical connection with a personal computer or use with USB cable connection.

6. The said Geiser Device as in claim 1 comprising a residing host that relates to an embedded descriptor system encoded and enhanced with descriptor recognizing program for document and pictorial imaging printing, copying, faxing or storage.

7. The said Geiser Device as in claim 1 comprising a software (SW) program in said embedded descriptor as a means for storage and transfer of data and images as said directly in the aforementioned electronic devices.

8. The said Geiser Device as in claim 2 comprising Printers, Photocopiers, Facsimiles, Cameras, Mobile Phones, Cell phones, MP3, DVDs, TV, Calculators, etc.

9. The said external slot in said Geiser Device as mentioned in claim 3 enabling said storage of data and images as aforementioned directly.

10. The said Geiser Device as in claim 1 in photocopiers, printers with said external slot allows for aforementioned storage of all forms of data and images directly.

11. The Geiser device bypasses the process of physical hardware connection between the cable, computer and document/data reproducing devices. It has the ability for reading, detecting and transferring of data in all its formats for the purpose of document reproduction either in printers or photocopiers.

12. It has the ability to directly recognize document and pictorial format such as *.txt, *.doc, *.jpg, *.pdf, *.ppt, *.tiff, *.xl, *.zip, and other MSOffice documents and print and not limited to MS operating system.
